(19) United States
(12) Patent Application Publication
(10) Pub. No.: US 2006/0161471 A1
(43) Pub. Date: Jul. 20, 2006

(54) System and method for multi-dimensional average-weighted banding status and scoring

(75) Inventors: Corey James Hulen, Sammamish, WA (US); Carolyn K. Chau, Carnation, WA (US); Vincent Feng Yang, Bothell, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/039,714

(22) Filed: Jan. 19, 2005

(51) Int. Cl. G06F 17/30

(52) U.S. Cl. 705/10

(57) ABSTRACT

Method and system for generating summary scores from heterogeneous measures retrieved from multi-dimensional data structures for monitoring organizational performance. Scorecards are created for each group of tree-structured measures branching from Parent nodes to child nodes based on Key Performance Indicators (KPI). Scores for each parent node may be obtained by rolling up scores for child nodes reporting to the parent node. KPI's at the lowest level are mapped on first scale, then mapped to a normalized scale, and score values determined. KPI scores are weight-averaged for roll-up to a parent node determining the score for that node. Multiple parent nodes may be rolled-up to a higher level node in a similar way. Multiple dimensions of the measure such as geographic and temporal may be scored simultaneously.

### BACKGROUND OF THE INVENTION

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators provide those measurements.

Key Performance Indicators are quantifiable measurements, agreed to beforehand, that reflect the critical success factors of an organization. They will differ depending on the organization. A business may have as one of its Key Performance Indicators the percentage of its income that comes from return customers. A school may focus a KPI on the graduation rates of its students. A Customer Service Department may have as one of its Key Performance Indicators, in line with overall company KPIs, percentage of customer calls answered in the first minute. A Key Performance Indicator for a social service organization might be number of clients assisted during the year.

Moreover, measures employed as KPI within an organization may include a variety of types such as revenue in currency, growth or decrease of a measure in percentage, actual values of a measurable quantity, and the like. This may make the task of comparing or combining different measures of performance a difficult task. A business scorecard can be modeled as a hierarchical listing of metrics where the score of leaf nodes drives the score of parent nodes. For example, a metric such as “customer satisfaction” may be determined by its child metrics such as “average call wait time” (measured in minutes), “customer satisfaction survey” (measured in a rating out of 10) and “repeat customers” (measured in number of repeat customers). Because the underlying metrics are of different data types, there is no obvious way to aggregate their performance into an overall score for customer satisfaction.

To complicate matters further, measures of performance may vary in scale between different sub-groups of an organization such as business group or geographic groups. For example, a sales growth of 10% from Asia may not necessarily be compared at the same level with a sales growth of 2% from North American organization, if the annual sales figures are $10 Million and $100 Million, respectively. Moreover, in multi-dimensional data, often used in On-Line Analytical Processing (OLAP) systems, the problem may be exacerbated by the fact that child objectives can have unbounded values and drastically vary in their actuals and targets along given dimensions. For example, if the scorecard were set to the geography of “North America” in the timeframe of “September”, average call wait time could have a target value of 3.2 and an actual reported value of 3.6, whereas if the timeframe were set to “December” the target value could be 3.2 with an actual reported value of 312. In January, the target and actual could be 0 and 12.1 respectively. Criteria such as “good”, “bad”, and “okay” may be difficult to define, when a scale of measure varies so greatly.

### SUMMARY OF THE INVENTION

Embodiments of the present invention relate to a system and method for employing multi-dimensional average-weighted banding, status, and scoring in measuring performance metrics. In accordance with one aspect of the present invention, a computer-implemented method generates summary scores from heterogeneous measures that can be stored in a multi-dimensional hierarchy structure.

In accordance with another aspect of the present invention, the computer-implemented method for generating the summary scores includes receiving data associated with at least one measure, determining boundaries for a group of contiguous bands, where the group of bands represents an actual scale between a worst case value and a best case value for the measure and a number of the actual bands is predetermined. The method further includes assigning a value within one of the actual bands of the group of bands to the received data based on a comparison of the data with the scale, determining a band percentage value based on dividing a first distance by a second distance, where the first distance is established by subtracting a first boundary of the actual band, in which the value is assigned, from the value and the second distance is established by subtracting the first boundary of the band from the second boundary of the actual band, establishing an evenly distributed scale comprising a number of evenly distributed bands, where a number of the evenly distributed bands is the same as the number of actual bands and the boundaries of the evenly distributed bands are equidistant, and mapping a new value on the evenly distributed scale to the value on the group of bands. The method concludes with determining a total band distance by subtracting a lower boundary value of an evenly distributed band, to which the new value is assigned, from an upper boundary of the same band, determining an in-band distance by multiplying the total band distance with the band percentage value, and determining a first score based on adding the lower boundary value of the evenly distributed band to the in-band distance.

In accordance with a further aspect of the present invention, a computer-readable medium that includes computer-executable instructions for generating summary scores from heterogeneous measures that can be stored in a multi-dimensional hierarchy structure is provided. The computer-executable instructions include retrieving data associated with at least one measure from a multi-dimensional database, determining an actual scale between a worst case value and a best case value for the measure that includes a predetermined number of actual bands, assigning a value within one of the actual bands to the retrieved data based on a comparison of the data with the actual scale, determining a band percentage value based on dividing a distance between a lower boundary of the actual band, in which the value is assigned and the value by a length of the actual band, establishing an evenly distributed scale comprising a number of evenly distributed bands, where a number of the evenly distributed bands is the same as the number of actual bands and boundaries of the evenly distributed bands are equidistant, and mapping a new value on the evenly distributed scale to the value on the actual scale.

The method further includes determining a total band distance by subtracting a lower boundary value of an evenly distributed band, to which the new value is assigned, from an upper boundary of the same band, determining an in-band distance by multiplying the total band distance with the band percentage value, and determining a KPI score based on adding the lower boundary value of the evenly distributed band to the in-band distance.

In accordance with still another aspect of the present invention, a system for generating summary scores from heterogeneous measures that can be stored in a multi-dimensional hierarchy structure includes a first computing device configured to store a multi-dimensional database that includes data associated with the heterogeneous measures, a second computing device in connection with the first computing device configured to receive user input associated with processing the data associated with the heterogeneous measures, and a third computing device that is configured to present the summary scores generated by a fourth computing device to at least one of a user and a network.

The system also includes the fourth computing device that is configured to execute computer-executable instructions associated with processing the heterogeneous measures. The fourth computer device is arranged to retrieve data associated with at least one measure from a multi-dimensional database, determine an actual scale between a worst case value and a best case value for the measure that includes a predetermined number of actual bands, assign a value within one of the actual bands to the retrieved data based on a comparison of the data with the actual scale, and determine a band percentage value based on dividing a distance between a lower boundary of the actual band, in which the value is assigned and the value by a length of the actual band. The fourth computing device is further arranged to establish an evenly distributed scale comprising a number of evenly distributed bands, where a number of the evenly distributed bands is the same as the number of actual bands and where boundaries of the evenly distributed bands are equidistant, map a new value on the evenly distributed scale to the value on the actual scale, and determine a total band distance by subtracting a lower boundary value of an evenly distributed band, to which the new value is assigned, from an upper boundary of the same band. The fourth computing device is also configured to determine an in-band distance by multiplying the total band distance with the band percentage value, and determine a KPI score based on adding the lower boundary value of the evenly distributed band to the in-band distance.

### BRIEF DESCRIPTION OF THE DRAWINGS

FIG. 1 illustrates an exemplary computing device that may be used in one exemplary embodiment of the present invention.

FIG. 2 illustrates an exemplary environment in which one exemplary embodiment of the present invention may be employed.

FIG. 3 illustrates an exemplary scorecard architecture according to one exemplary embodiment of the present invention.

FIGS. 4A and 4B illustrate screen shots of two exemplary scorecards generated according to one exemplary embodiment of the present invention.

FIG. 5 illustrates a screen shot of a scorecard customization portion of a software application employing multi-dimensional banding according to one embodiment of the present invention.

FIG. 6 illustrates an exemplary group of KPI bands that may be used in one exemplary embodiment of the present invention.

FIG. 7 illustrates an exemplary scorecard with KPI roll-ups according to one embodiment of the present invention.

FIG. 8 illustrates an exemplary deployment environment for a scorecard software application in accordance with the present invention.

FIG. 9 illustrates an exemplary strategy map according to one embodiment of the present invention.

FIG. 10 illustrates an exemplary scorecard with banding in accordance with the present invention.

FIG. 11 illustrates an exemplary logical flow diagram of a scorecard creation process in accordance with the present invention.

FIG. 12 illustrates an exemplary logical flow diagram of a scorecard roll-up process in accordance with the present invention.

FIG. 13 illustrates an exemplary logical flow diagram of a score determination process in accordance with the present invention.

### DETAILED DESCRIPTION

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

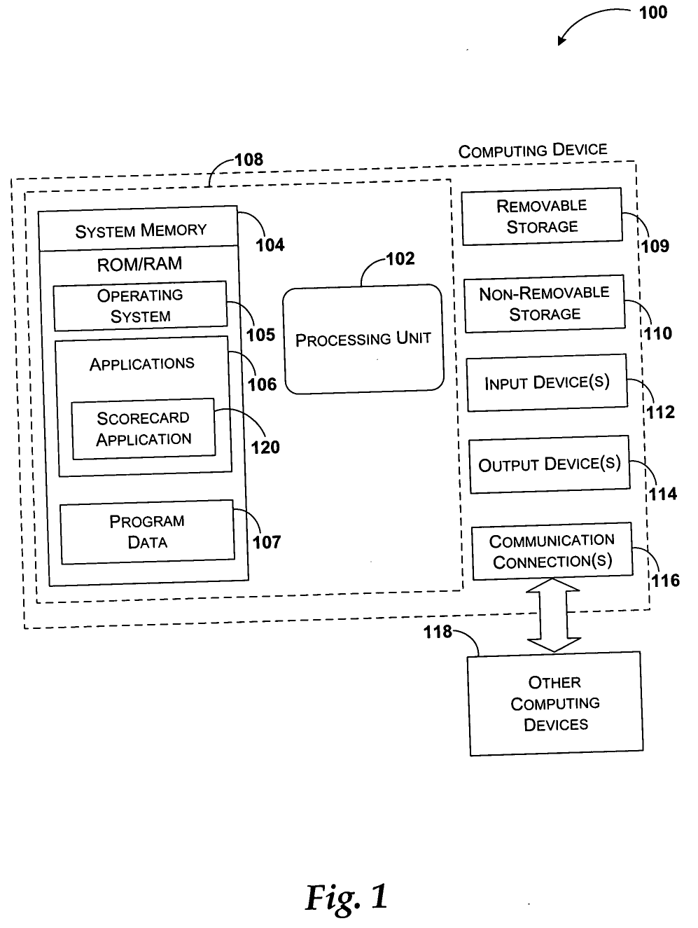

Referring to FIG. 1, an exemplary system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes an operating system 105, one or more applications 106, and may include program data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. All these devices are known in the art and need not be discussed at length here.

Computing device 100 also contains communications connection(s) 116 that allow the device to communicate with other computing devices 1118, such as over a network or a wireless mesh network. Communications connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one embodiment, applications 106 further include an application 120 for implementing scorecard calculation functionality and/or a multi-dimensional database in accordance with the present invention. The functionality represented by application 120 may be further supported by additional input devices, 112, output devices 114, and communication connection(s) 116 that are included in computing device 100 for configuring and deploying a scorecard calculation application.

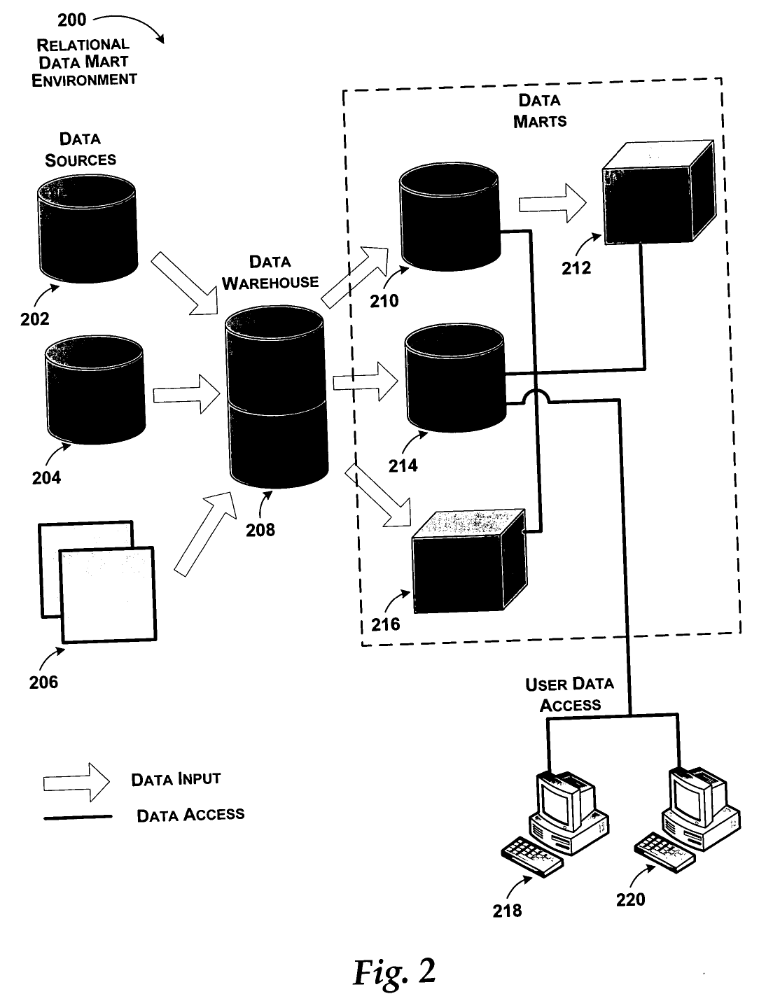

FIG. 2 illustrates an exemplary environment in which one exemplary embodiment of the present invention may be employed. With reference to FIG. 2, one exemplary system for implementing the invention includes a relational data sharing environment, such as data mart environment 200. Data mart environment 200 may include implementation of a number of information systems such as performance measures, business scorecards, and exception reporting. A number of organization-specific applications including, but not limited to, financial reporting/analysis, booking, marketing analysis, customer service, and manufacturing planning applications may also be configured, deployed, and shared in environment 200.

A number of data sources such as SQL server 202, database 204, non multi-dimensional data sources such as text files or EXCEL® sheets 20 may provide input to data warehouse 208. Data warehouse 208 is arranged to sort, distribute, store, and transform data. In one embodiment, data warehouse 208 may be an SQL server.

Data from data warehouse 208 may be distributed to a number of application-specific data marts. These include direct SQL server application 214, analysis application 216 and a combination of SQL server (210)/analysis application (212). Analyzed data may then be provided in any format known to those skilled in the art to users 218, 220 over a network. In another embodiment, users may directly access the data from SQL server 214 and perform analysis on their own machines. Users 218 and 220 may be remote client devices, client applications such as web components, EXCEL® applications, business-specific analysis applications, and the like.

The present invention is not limited to the above described environment, however. Many other configurations of data sources, data distribution and analysis systems may be employed to implement a summary scoring system for metrics from a multi-dimensional source without departing from the scope and spirit of the invention.

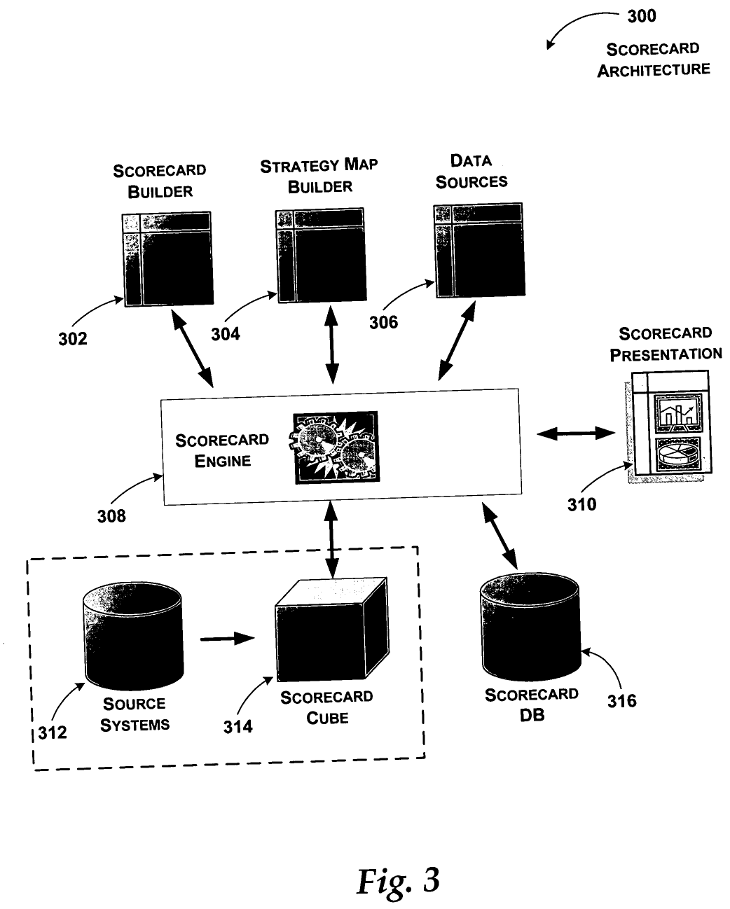

FIG. 3 illustrates an exemplary scorecard architecture according to one exemplary embodiment of the present invention. Scorecard architecture 300 may comprise any topology of processing systems, storage systems, source systems, and configuration systems. Also, scorecard architecture 300 may have a static or dynamic topology without departing from the spirit and scope of the present invention.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application software that is arranged to evaluate performance metrics. Scorecard engine 308 may be loaded into a server, executed over a distributed network, executed in a client device, and the like.

Data for evaluating various measures may be provided by a data source. The data source may include source systems 312, which provide data to a scorecard cube 314. Source systems 312 may include multi-dimensional databases such OLAP, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a GUI, and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources 306 may also define KPI mappings and other associated data.

Finally, scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like.

Illustrative Embodiments for Multi-dimensional Average-weighted Banding Status and Scoring

Embodiments of the present invention are related to generating summary scores for heterogeneous measures of performance. Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes are:

Frequency of Data:

The frequency of data identifies how often the data is updated in the source database (cube). The frequency of data may include: Daily, Weekly, Monthly, Quarterly, and Annually.

Unit of Measure:

The unit of measure provides an interpretation for the KPI. Some of the units of measure are: Integer, Decimal, Percent, Days, and Currency. These examples are not exhaustive, and other elements may be added without departing from the scope of the invention.

Trend Type:

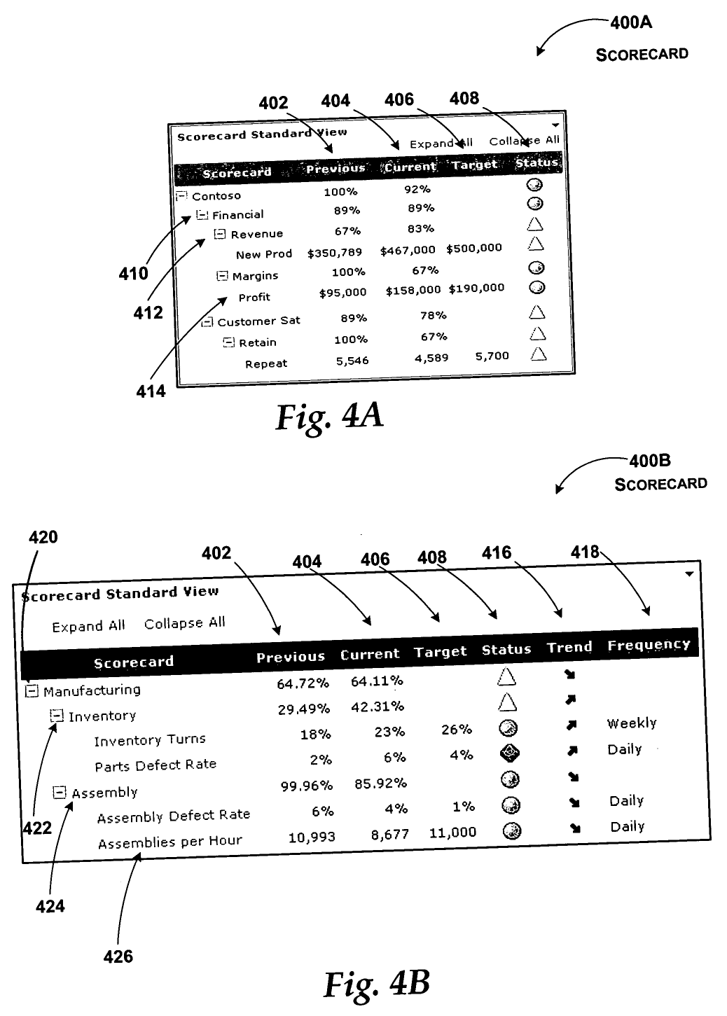

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the General scorecard of FIG. 4B indicate how the numbers are moving this period compared to last. If in this period the number is greater than last period, the trend is up regardless of the trend type. Possible trend types may include: Increasing Is Better, Decreasing Is Better, and On-Target Is Better.

Weight:

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other Attributes:

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

FIGS. 4A and 4B illustrate screen shots of two exemplary scorecards generated according to one exemplary embodiment of the present invention.

When defining a scorecard, there are a series of elements that may be used. These elements may be selected depending on a type of scorecard such as a Balanced scorecard or a General scorecard. The type of scorecard may determine which elements are included in the scorecard and the relationships between the included elements such as Perspectives, Objectives, KPIs, KPI groups, Themes and Initiatives. Each of these elements has a specific definition and role as prescribed by the scorecard methodology.

Often the actual elements themselves, i.e. a Financial Perspective or a Gross Margin % KPI—might be elements that apply to more than one scorecard. By defining each of these items in a scorecard elements module, a “shared” instance of that object is created. Each scorecard may simply reference the element and need not duplicate the effort in redefining the item.

Some of the elements may be specific to one type of scorecard such as Perspectives and Objectives. Others such as KPI groups may be specific to other scorecards. Yet some elements may be used in all types of scorecards. However, the invention is not limited to these elements. Other elements may be added without departing from the scope and spirit of the invention.

One of the key benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

In an exemplary scorecard methodology, a series of objectives within each of a set of designated perspectives are identified that support the overall strategy. If the exemplary scorecard methodology is followed, objectives are identified for all perspectives to ensure that a well-rounded approach to performance management is followed.

In the above described exemplary scorecard methodology, a Perspective is a point of view within the organization by which Objectives and metrics are identified to support the organizational strategy. Users viewing a scorecard may see Objectives and metrics in hierarchies under their respective Perspectives. An Objective is a specific statement of how a strategy will be achieved. Following is an example of three typical Perspectives with exemplary Objectives for each:

Financial

Increase Services Revenue

Maintain Overall Margins

Control Spending

Customer Satisfaction

Retain Existing Customers

Acquire New Customers

Improve Customer Satisfaction

Operational Excellence

Understand Customer Segments

Build Quality Products

Improve Service Quality

First column of FIG. 4A shows elements of an exemplary scorecard for a fictional company called Contoso. First Perspective 410 “Financial” has first Objective 412 “Revenue Growth” and second Objective “Margins Improvement” reporting to it. Second Perspective Customer Satisfaction has Objective Retain Existing Customers reporting to it.

Second Objective “Margin Improvement” has KPI 414 Profit reporting to it. Second column 402 in scorecard 400A shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400A. Target values may be retrieved from a database, entered by a user, and the like. Column 408 of scorecard 400A shows status indicators.

Status indicators convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands.

FIG. 4B shows another scorecard (400B). The main difference between scorecard 400B and scorecard 400A is the lack of Objectives and Perspectives in scorecard 400B. Instead scorecard 400B includes KPI groups 422 and 424. Columns 402-408 of scorecard 400B are substantially similar to likewise numbered columns of scorecard 400A.

Additional column 416 includes trend type arrows as explained above under KPI attributes. Column 418 shows another KPI attribute, frequency.

Some organizations prefer to create scorecards that do adhere to one type of scorecard methodology such as Balanced Scorecard Methodology. Others may prefer general scorecards that provide a more flexible definition for the scorecard. The invention is, however, not limited to these exemplary methodologies. Other embodiments may be implemented without departing from the scope and spirit of the invention. KPI groups may be used to roll up KPIs or other KPI groups to higher levels. Structuring groups and KPIs into hierarchies provides a mechanism for presenting expandable levels of detail in a scorecard. Users may review performance at the KPI group level, and then expand the hierarchy when they see something of interest.

KPI groups are containers for other groups and for KPIs. Each group has characteristics similar to KPIs. Groups may contain other groups or KPIs. For example, a KPI group may be defined as a Regional Sales group. The Regional Sales group may contain four additional groups: North, South, East, and West. Each of these groups may contain KPIs. For example, West might contain KPIs for California, Oregon, and Washington.

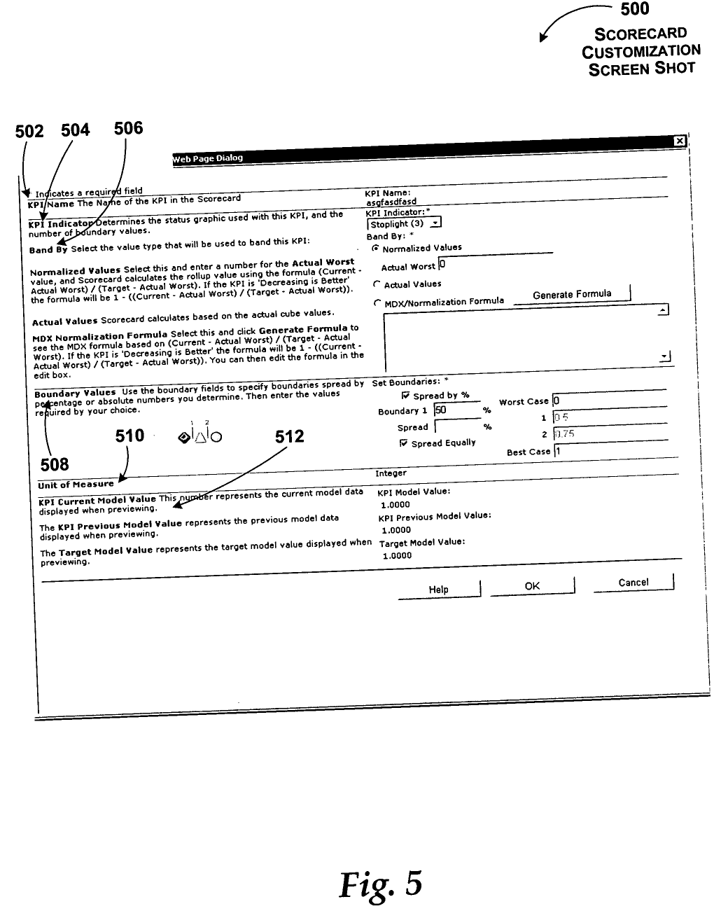

FIG. 5 illustrates a screen shot of a scorecard customization portion of a software application employing multi-dimensional banding according to one embodiment of the present invention.

Screen shot 500 is an example of a scorecard application's user interface.

At the top of the screen KPI Name 502 indicates to the user, which KPI is being generated or reconfigured. The next item is KPI Indicator 504. As discussed previously, default or user-defined indicators may be selected to represent KPI values graphically. The user may select from a drop-down menu one of a 3-level Stoplight indicator scheme, sliding scale band scheme, or another scheme.

The next section determines how the banding process is to be employed.

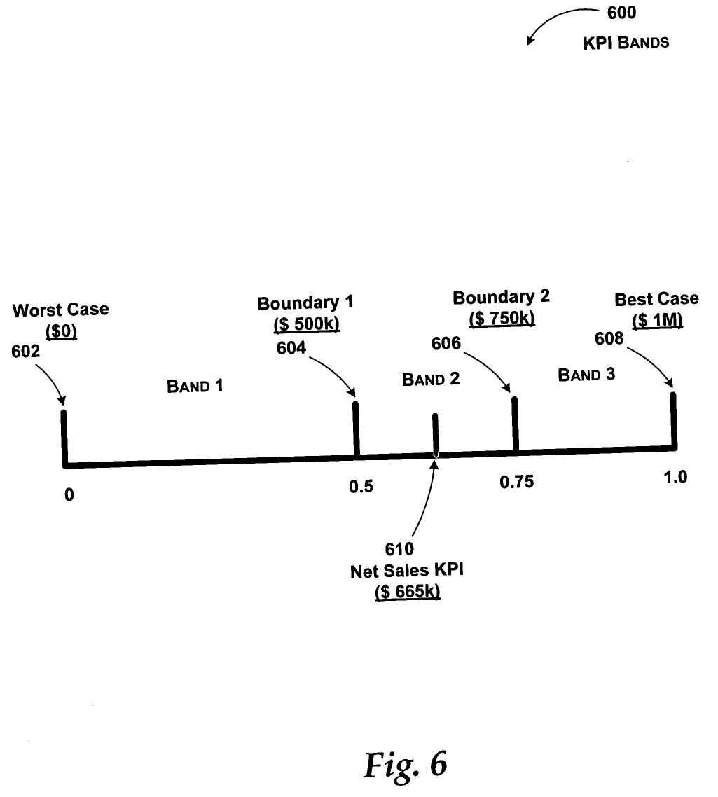

The user may select under Band By section 506 from normalized value, actual values, or Multi Dimensional eXpression (MDX) normalization. Details of the banding process are discussed below in conjunction with FIG. 6.

The next section, designated by Boundary Values 508, enables the user to select boundary values. As described, one embodiment of the present invention determines scores for each KPI based on mapping a KPI value to a scale comprising a predetermined number of bands. For example, using the 3-level Stoplight scheme, the scale comprises three bands corresponding to the good, neutral, and bad indicators. In this section the user may enter values for the worst case and best case defining two ends of the scale and boundaries 1 and 2 separating the bands between the two ends.

Furthermore, the user may elect to have an equal spread of the bands or define the bands by percentage.

Next, the user may define a Unit of Measure 510 for the KPI. The unit of measure may be an Integer, Decimal, Percent, Days, and Currency. The scorecard application may also provide the user with feedback on the model values, as shown by Model Values 512, that are used in the score representation for previous, current, and target values.

FIG. 6 illustrates an exemplary group of KPI bands that may be used in one exemplary embodiment of the present invention.

Banding is a method used to set the boundaries for each increment in a scale (actual or evenly distributed) indicated by a stoplight or level indicator. KPI banding provides a mechanism to relate a KPI value to the state of the KPI indicator. Once a KPI indicator is selected, the value type that is to be used to band the KPI may be specified, and the boundary values associated with the value type. KPI banding may be set while creating the KPI, although it may be more efficient to do so after all the KPIs exist.

The KPI value is reflected in its associated KPI indicator level. When creating a KPI, first a number of levels of the KPI indicator is defined. A default may be three, which may be graphically illustrated with a traffic light. Banding defines the boundaries between the levels. The segments between those boundaries are called bands. For each KPI there is a Worst Case boundary and a Best Case boundary, as well as (x-1) internal boundaries, where x is the number of bands. The worst and best case values are set to the lowest and highest values, respectively, based on expected values for the KPI.

The band values, i.e. the size of each segment may also be set by the user based upon a desired interpretation of the KPI indicator. The bands do not have to be equal in size.

In the example shown in FIG. 6, KPI bands 600 are for a Net Sales KPI, which has a Unit of Measure of currency. A stoplight scheme is selected, which contains three bands and the worst case (602) and the best case (608) are set to $0 and $IM, respectively. The boundaries are set such that a value up to $500 k is in band 1, a value between $500 k and $750 k is in the band 2, and values above $750 k are in band 3.

In the example, a KPI value of $667 k (610) is placed two thirds of the way into the second band. The indicator is colored (e.g. yellow). Its normalized value is 0.6667.

According to one embodiment of the present invention, four banding types may be employed: Normalized, Actual Values, Cube Measure, and MDX Formula. The mapped KPI value is the number that is displayed to the user for the KPI.

A Band By selector may allow users to determine what value is used to determine the status of the KPI and also used for the KPI roll-up. The Band By selector may display the actual value to the user, but use a normalized or calculated score to determine the status and roll-up of the KPI. The boundaries may reflect the scale of the Band By values.

For example, a user may be creating a scorecard, which compares the gross sales amounts for all of the sales districts. When the KPI “Gross Sales” is mapped in scorecard mapping, the “Gross Sales” number is determined that is displayed to the user. However, because the sales districts are vastly different in size, a sales district that has sales in the $100,000 range may have to be compared to another sales district that has sales in the $10,000,000 range. Because the absolute numbers are so different in scale, creating boundary values that encompass both of these scales may not provide practical analyses. So, while displaying the actual sales value, the application may normalize the sales numbers to the size of the district (i.e. create a calculated member or define an MDX statement that normalizes sales to a scale of 1 to 100). Then, the boundary values may be set against the 1 to 100 normalized scale for determining the status of the KPI. Sales of $50,000 in the smaller district may be equivalent to sales of $5,000,000 in the larger district. A pre-normalized value may show that each of these sales figures is 50% of the expected sales range, thus the KPI indicator for both may be the same—a yellow coloring, for example.

Normalized:

Normalized values may be expressed as a percentage of the Target value, which is generally the Best Case value. For example, a three-band indicator with four boundaries, may be defined by the following default values: Worst Case=0; boundary (1)=0.5; boundary (2)=0.75; Best Case=1.

Normalized values may be applied for both KPI trend type Increasing is Better and KPI trend type Decreasing is Better.

Actual Values:

Actual values are on the same scale as the values one expects to find in the KPI. If an organization has a KPI called “Net Sales,” with expected KPI and uses actual values from 0 to 30,000, the three-level indicator may be defined as follows: Worst Case=0; boundary (1)=15,000; boundary (2)=22,5000; Best Case=30,000.

The invention is not limited to the above described exemplary values for boundaries and bands. Other values may be employed without departing from the scope and spirit.

Cube Measure:

The banding value is a cube measure and assumed to be a normalized value or a derived “score”. In many instances, a cube measure may be more useful when calculating a banding value than an actual number. For example, when tracking defects for two product divisions, division A has 10 defects across the 100 products they produce, and division B has 20 defects across the 500 products they produce. Although division B has more defects, their performance is in fact better than division A. In a scorecard the Actual values may display 10 and 20, respectively. But using a normalized cube measure for banding may show division A with a 10% defect rate and division B with a 4% rate, and set their KPI indicators accordingly. A key characteristic of the Cube Measure is that it is retrieved from a data store (e.g. a multi-dimensional OLAP cube) and not calculated by the scorecard engine.

MDX Formula:

An MDX formula may also be used to define the banding. The MDX formula serves the same purpose as the “Cube Measure” option, except the calculation may be kept in the scorecard application rather than in the data analysis application.

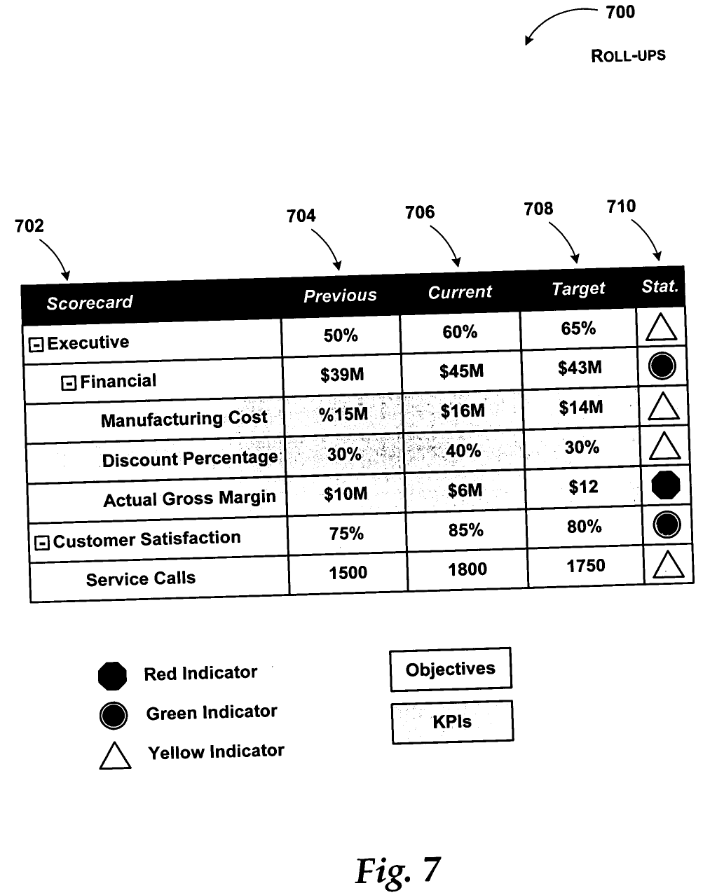

FIG. 7 illustrates an exemplary scorecard with KPI roll-ups according to one embodiment of the present invention. Exemplary scorecard 700 includes three Objectives in column 702. The Objective “Financial” has three KPIs rolling up to it and “Financial” rolls up to another Objective “Executive”. KPI Service Calls rolls up to Objective “Customer Satisfaction”. KPIs Manufacturing Cost, Discount Percentage, and Actual Gross Margin roll up to Objective “Financial”.

Columns 704, 706, and 708 include metric values for previous, current, and target values, respectively, of the listed Objectives and KPIs. Column 710 includes status indicators for each KPI and Objective. In this exemplary scorecard, status indicators have been used according to a commonly used 3-level Stoplight scheme.

Calculation of KPI scores by banding is described above. Once scores for each KPI is determined, the KPI scores may be rolled up to their respective Objectives. If weight factors are assigned to KPIs, a weighted average process is followed. For the weighted average process each KPI score is multiplied with its assigned weight factor, all KPIs multiplied with weight factors added together, and the sum divided by a total of all weight factors.

As mentioned previously, Objective may roll up to other Objectives, or to Perspectives. Depending on how the roll-up relationships are defined, Objectives and Perspectives may then be rolled up to the next higher branch of the tree structure employing the same methodology. When each node (Perspective, Objective, KPI) of the tree is determined, a status indicator may be assigned and presented on the scorecard.

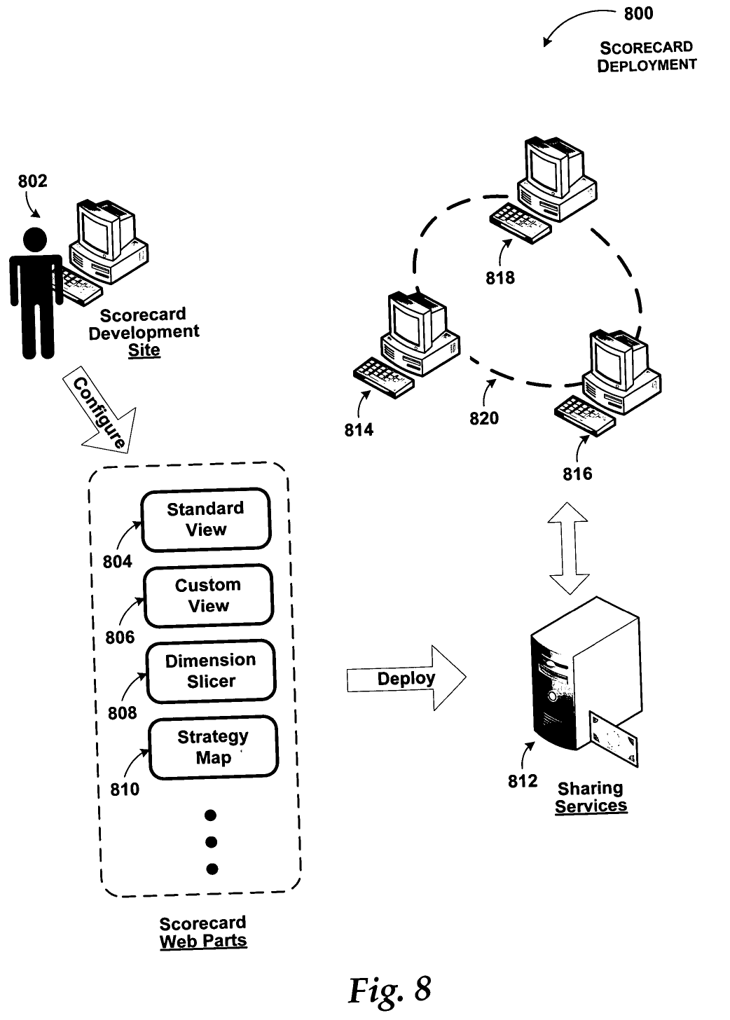

FIG. 8 illustrates an exemplary deployment environment for a scorecard software application in accordance with the present invention. System 800 may include as its backbone an enterprise network, a Wide Area Network (WAN), independent networks, individual computing devices, and the like. According to one embodiment, scorecard deployment begins at scorecard development site 802. Scorecard development site 802 may be a shared application at an enterprise network, an independent client device, or any other application development environment.

One of the tasks performed at scorecard development site 802 is configuration of the scorecard application. Configuration may include selection of default parameters such as worst and best case values, boundaries for bands, desired KPIs for roll-up to each Objective, and the like. For interaction with users, the scorecard application may employ web components, such as graphic presentation programs and data entry programs. During configuration of the scorecard application, web parts may be selected, such as standard view 804, custom view 806, dimension slicer 808, and strategy map 810.

Once the scorecard application is configured and desired web parts selected, it may be deployed to sharing services 812. Sharing services 812 may include a server that is responsible for providing shared access to clients over one or more networks. Sharing services 812 may further perform security tasks ensuring confidential data is not released to unauthorized recipients.

In another embodiment, sharing service 812 may be employed to receive feedback from recipients of scorecard presentation such as corrected input, change requests for different configuration parameters, and the like. Sharing services 812 may interact with scorecard development site 802 and forward any feedback information from clients.

Recipients of scorecard presentation may be individual client devices and/or applications on a network such as clients 814, 816, and 818 on network 820. Clients may be computing devices such as computing device 100 of FIG. 1, or an application executed in a computing device. Network 820 may be a wired network, wireless network, and any other type of network known in the art.

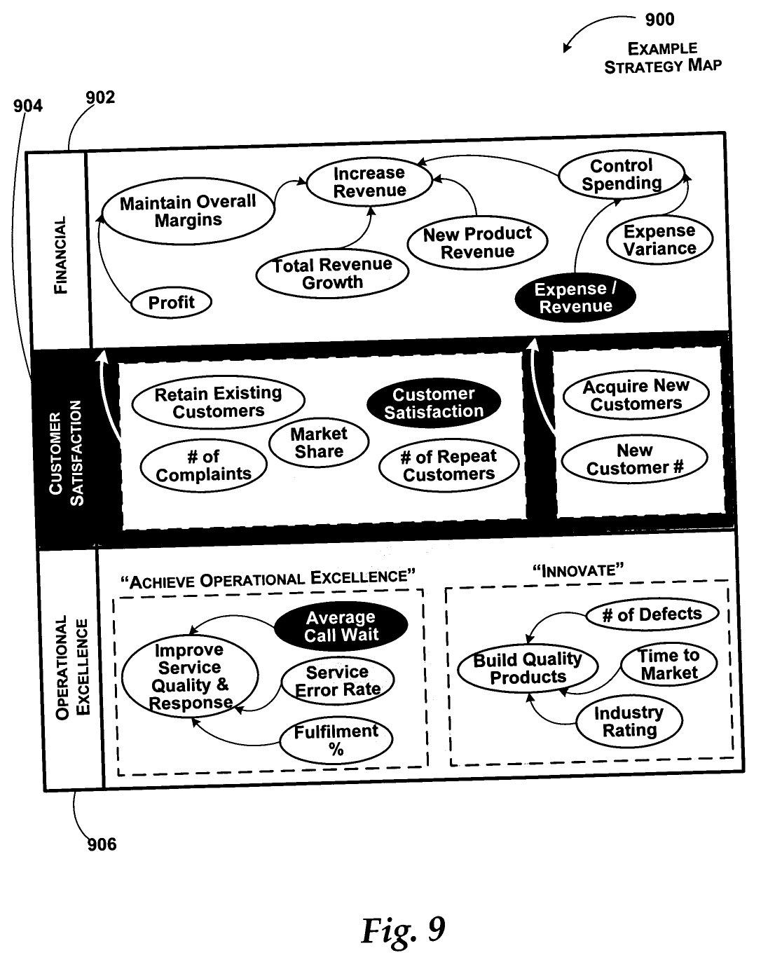

FIG. 9 illustrates an exemplary strategy map according to one embodiment of the present invention. A strategy map is one example of scorecard representation. It provides a visual presentation of the performance evaluation to the user. The invention is not limited to strategy maps, however. Other forms of presentation of the performance evaluation based on the scorecard data may be implemented without departing from the scope and spirit of the invention. Strategy map 900 includes three exemplary levels of performance evaluation.

As described before, measures of performance evaluation may be structured in a tree-structure starting with KPIs, which roll up to Objectives, which in turn roll-up to Perspectives. There may be a plurality of each level of metrics, some of which may be grouped under a category. According to one embodiment of the present invention, KPIs and Objectives may be grouped under categories called Themes or Initiatives. Strategy maps are essentially graphical representations of the roll-up relations, and categories of metrics determined by a scorecard application.

Themes are containers that may exist in a scorecard, and linked to one or more Objectives that have already been assigned to a Perspective. A Theme may also be linked to one or more KPI groups that have already been used as levels in the scorecard.

An Initiative is a program that has been put in place to reach certain Objectives. An Initiative may be linked to one or more Objectives that have already been assigned to a Perspective. An Initiative may also be linked to one or more KPI groups that have already been used as levels in the scorecard.

Exemplary strategy map 900 shows three Perspectives (902, 904, 906). The first Perspective (902) is “Financial”, which includes KPI profit reporting to Objective Maintain Overall Margins. KPIs expense-revenue ratio and expense variance roll up to Objective Control Spending. Objectives Maintain Overall Margins and Control Spending roll up to Objective Increase Revenue. Objective Increase Revenue also gets roll-ups from KPIs total revenue growth and new product revenue.

In a color application, strategy map 900 may assign colors to each KPI, Objective, and Perspective based on a coloring scheme selected for the indicators by the scorecard. For example, a three-color (Green/Yellow/Red) scheme may be selected for the indicators of the scorecard. In that case individual ellipses representing KPIs, Objectives, and Perspectives may be filled with the color of their assigned indicator. In the figure, no-fill indicates yellow color, lightly shaded fill indicates green, and darker shade fill indicates red color. An overall weighted average of all Perpective (and/Objectives) within a Theme may determine the color of the Theme box.

The second example in strategy map 900 shows Perspective 904 “Customer Satisfaction”. In this case, Perspective 904 includes a plurality of KPIs but no Objectives. The KPIs are grouped in two Themes. While individual KPIs under “Customer Satisfaction” such as Retain Existing Customers, New Customer Number, and Market Share have different indicator colors, what determines the overall color of a Perspective is the weighted average of the metrics within the Perspective. In this example, Perspective 904 is darkly shaded indicating that the overall color is red due to a high weighting factor of the KPI Customer Satisfaction, although it is the only KPI with red color.

The third example shows Perspective 906 “Operational Excellence”. Under “Operational Excellence”, two categories of metrics are grouped together. The first one is Initiative “Achieve Operational Excellence”. The second Initiative is “Innovate”. As shown in the figure, both Initiatives have Objectives and KPIs rolling up to the Objectives. The overall color of Perspective 906 is again dictated by the weighted average of the metrics within the Perspective.

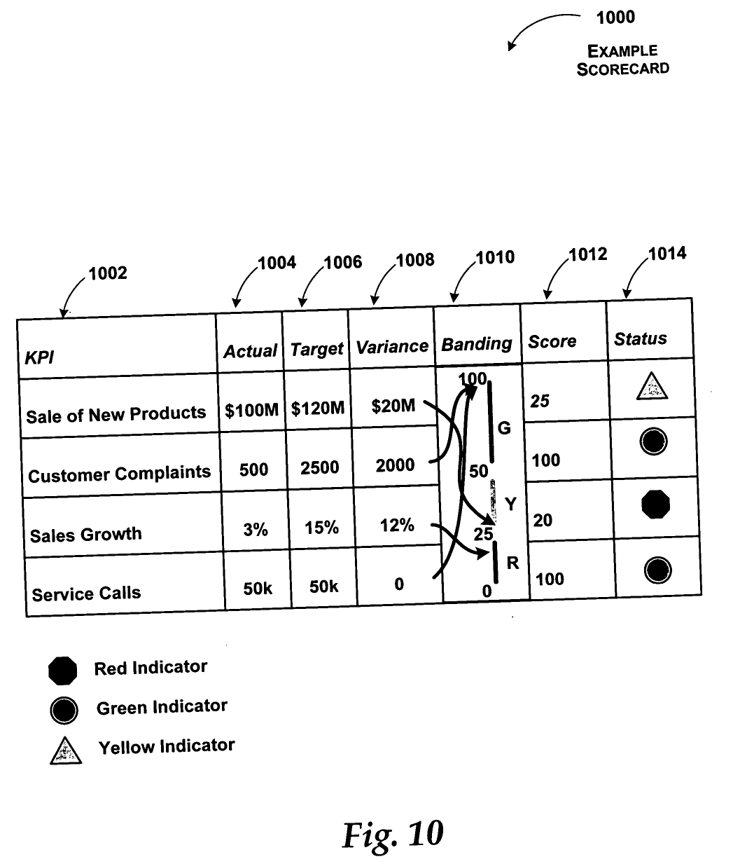

FIG. 10 illustrates an exemplary scorecard with banding in accordance with the present invention. Scorecard 1000 includes four KPIs in column 1002, Sale of New Products, Customer Complaints, Sales Growth, and Service Calls.

Columns 1004 and 1006 include actual and target values for each metric, and column 1008 shows the variance between columns 1004 and 1006.

The examples in scorecard 1000 are illustrative of how units of metrics may vary. Sale of New Products is expressed in Million Dollars, Customer Complaints in actual number, Sales Growth in percentage, and Service Calls in actual number.

To compare and evaluate these widely varying metrics, first an actual banding is performed as described in conjunction with FIGS. 6 and 7. Then actual band values are mapped to an evenly distributed band, where using in-band distance and total band distance scores may be calculated for each KPI.

As discussed before, boundaries for the actual bands and indicator types may be selected by the user or by default. The exemplary bands shown in column 1010 use the default Green/Yellow/Red scheme with a 0-25-50-100 spread. Scores calculated according to the methods discussed in FIGS. 6 and 7 are shown in column 1012.

Finally, a score indicator may be assigned to each score based on the scheme used to select colors and boundaries for the bands. The illustrated scheme includes a green circle for good performance, a yellow triangle for neutral performance, and a red octagon for bad performance. While scorecard 1000 shows four independent KPIs, other embodiments may include a number of branched Perspective, Objective, KPI combinations. Additional information such as trends may also be included in the scorecard without departing from the scope of the present invention.

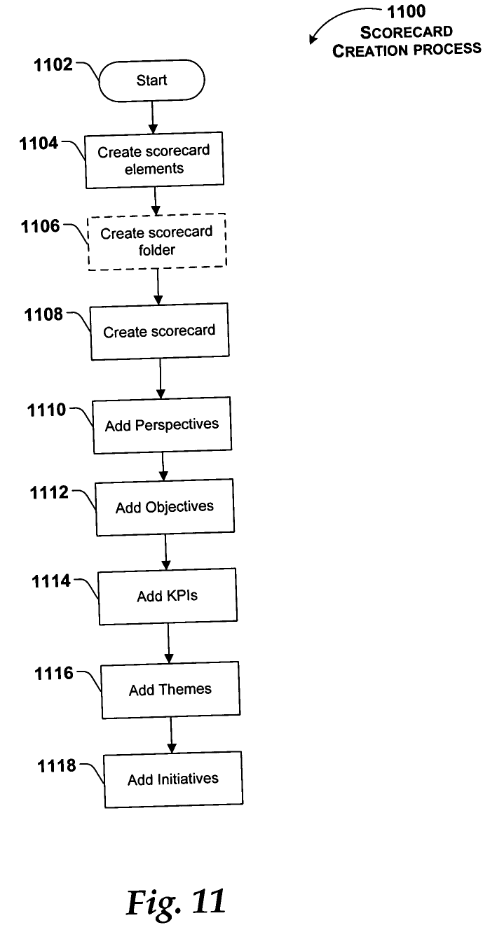

FIG. 11 illustrates an exemplary logical flow diagram of a scorecard creation process in accordance with the present invention. Process 1100 may be performed in scorecard engine 308 of FIG. 3.

Process 1100 starts at block 1102 with a request for creation of a scorecard. Processing continues at block 1104. At block 1104 scorecard elements are created. A user may create elements such as KPIs, Objectives, Perspectives, and the like all at once and define the relationships, or add them one at a time. Processing then proceeds to optional block 1106.

At optional block 1106, a scorecard folder may be created. Scorecard folders may be useful tools in organizing scorecards for different organizational groups, geographic bases, and the like. Processing moves to block 1108 next.

At block 1108, a scorecard is created. Further configuration parameters such as strategy map type, presentation format, user access, and the like, may be determined at this stage of scorecard creation process.

The five blocks following block 1108 represent an aggregation of different elements of a scorecard to the created scorecard. As mentioned above, these steps may be performed all at once at block 1104, or one at a time after the scorecard is created. While the flowchart represents a preferred order of adding the elements, any order may be employed without departing from the scope and spirit of the present invention.

In the exemplary scorecard creation process (1100), block 1108 is followed by block 1110, where Perspectives are added. Block 1110 is followed by block 1112, where Objectives are added. Block 1112 is followed by block 1114, where KPIs are added. At each of these three blocks attributes of the element such as frequency, unit of measure, and the like, may be configured. Moreover, as each element is added, roll-up relationships between that element and existing ones may also be identified.

Block 1114 is followed by 1116, where Themes are added. Themes are containers that may be linked to one or more Objectives that have already been assigned to a Perspective, or to one or more KPI groups that have already been used as levels in the scorecard. Processing advances to block 1118.

At block 1118, Initiatives are added. An Initiative is a program that has been put in place to reach certain Objectives.

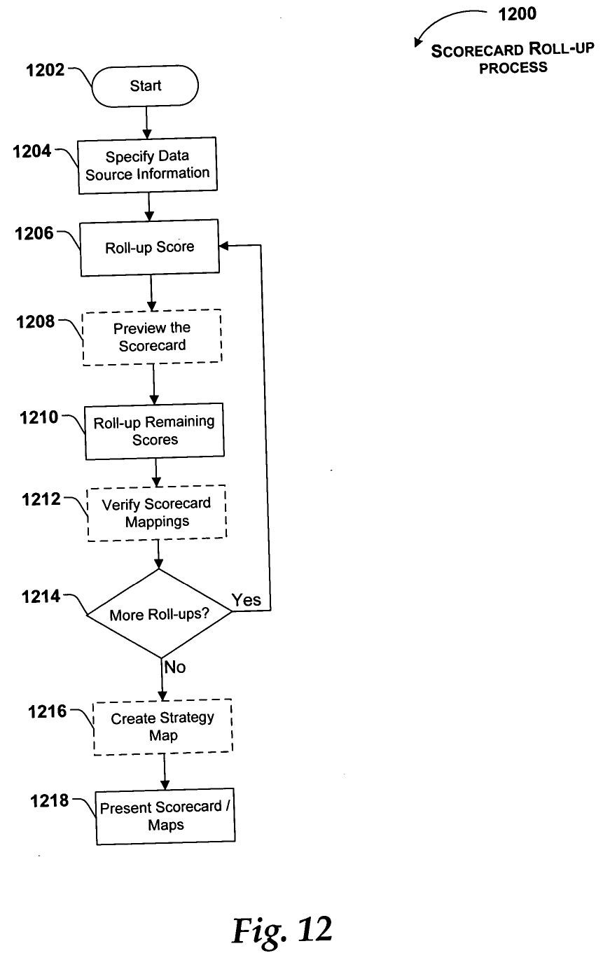

FIG. 12 illustrates an exemplary logical flow diagram of a scorecard roll-up process in accordance with the present invention. Process 1200 may also be performed in scorecard engine 308 of FIG. 3.

Process 1200 starts at block 1202. Processing continues at block 1204. At block 1204 data source information is specified. A user may define relationships between KPIs, Objectives, and Perspectives. The defined relationships determine which nodes get rolled up to a higher level node. Processing then proceeds to block 1206.

At block 1206, a score for a parent node is rolled up from reporting child nodes. A parent node may be an Objective with KPIs or other Objectives as child nodes, a KPI group with KPIs or other KPI groups as child nodes, and a Perspective with Objectives as child nodes. A method for calculating the roll-up of KPIs to an Objective is described in detail in conjunction with FIG. 7. Processing moves to optional block 1208 next.

At optional block 1208, a user may be given the option of previewing the scorecard. Along with the preview, the user may also be given the option of changing configuration parameters at this time. Processing then advances to optional block 1210.

At optional block 1210, remaining scores are rolled-up for all parent nodes. In some scorecards, KPI groups may replace Objectives, but the methodology remains the same. Processing then proceeds to optional block 1212.

At optional block 1212, scorecard mappings are verified. The user may make any changes to the relationships between different nodes at this time in light of the preliminary rolled-up scores, and correct any configuration parameters. Processing then proceeds to decision block 1214.

At block 1214, a determination is made whether a higher level roll-up is needed such as Objectives rolling up to Perspective(s) or to other Objective(s). In some scorecards, this may be the equivalent of different levels of KPI's and KPI groups being rolled up into the higher level ones. If the decision is negative, processing proceeds to optional block 1216.

At optional block 1216 a strategy map may be created based on the user-defined parameters. Processing then moves to block 1218, where the scorecard and optional maps are presented. As described before, presentation of the scorecard may take a number of forms in a deployment environment such as the one described in FIG. 8.

If the decision at block 1214 is affirmative, processing returns to block 1206 for another round of roll-up actions. In one embodiment, roll-ups of nodes at the same level may be performed simultaneously. In another embodiment, roll-ups of one branch of the tree structure may be performed vertically and then roll-ups of another branch pursued. The roll-up process continues until all child nodes have been rolled up to their respective parent nodes.

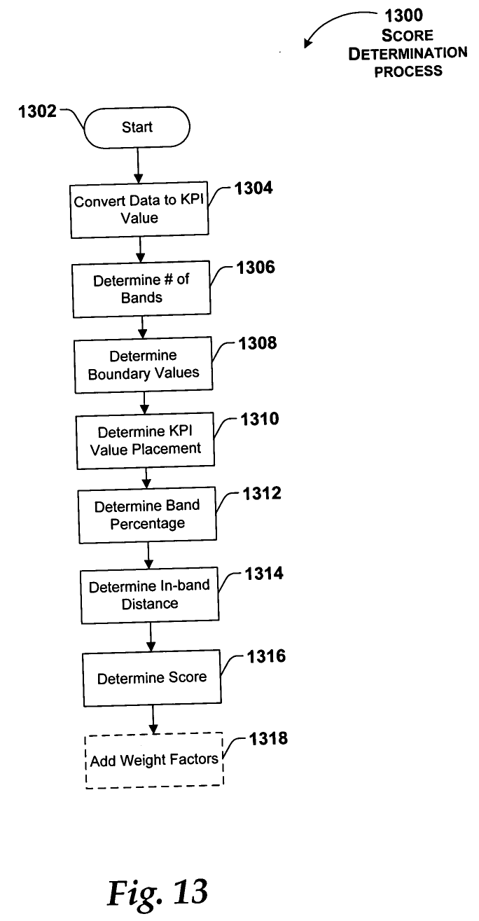

FIG. 13 illustrates an exemplary logical flow diagram of a score determination process in accordance with the present invention. Process 1300 may be performed in scorecard engine 308 of FIG. 3.

Process 1300 starts at block 1302, where data associated with a metric is retrieved from a data source. Processing continues at block 1304. At block 1304 data is converted to a KPI value. In one embodiment, the conversion may be determining a variance between an actual value and a target value. Processing then proceeds to block 1306.

At block 1306, a number of bands for the actual scale is determined. The number of bands may be provided by default parameters, by user input, and the like. Processing moves to block 1308 next.

At block 1308, boundary values for the bands determined at block 1306 are established. A user may enter boundary values individually, as a spread, or in percentages. In one embodiment, the user may select the boundaries to be equidistant or utilize values provided by default parameters.

At the following block, 1310, KPI value is mapped to the actual scale. Processing then proceeds to block 1312, where a band percentage is determined by dividing a distance between the mapped value and the lower boundary of the assigned band by a total length of the assigned band. Processing next moves to block 1314.

At block 1314 the KPI value on the actual scale is mapped to an evenly distributed scale, and an in-band distance is determined by multiplying a length of the new evenly distributed band with the band percentage. The determination of the actual scale and the evenly distributed scale as well as the mapping of the KPI values to determine the score are explained in detail in FIG. 6. Processing advances to block 1316 next.

At block 1316, the score is determined by adding the in-band distance to the length(s) of any bands between the lower end (worst case) and the assigned band. Following block 1316, at optional block 1318, weight factors may be added to the KPI scores before they are rolled up to the next level.

The above specification, examples and data provide a complete description of the manufacture and use of the composition of the invention. Since many embodiments of the invention may be made without departing from the spirit and scope of the invention, the invention resides in the claims hereinafter appended.

What is claimed is:

1. A computer-implemented method for generating summary scores from heterogeneous measures, the method comprising:
determining a first position of a first value within a first scale, wherein the scale is banded by a lower bound value and an upper bound value and the first value corresponds to a first measure of the heterogeneous measures;
translating the first value to a second normalized value, wherein the second normalized value corresponds to a second position within a second scale such that the second normalized value corresponds to a score for the first value; and
translating the second normalized value to a third weighted value, wherein the third weighted value takes into consideration an assigned weight relative to other measures of the same parent node;
rolling up the third weighted value with additional weighted values corresponding to additional measures of the heterogeneous measures such that the summary score is generated.

2. The computer-implemented method of claim 1, wherein rolling up the third weighted value with additional weighted values further comprises translating the third weighted value to another weighted value, wherein the other weighted value takes into consideration an assigned relative weight of the other parent nodes.

3. The computer-implemented method of claim 1, wherein the first value is substantially equal to the normalized second value.

4. The computer-implemented method of claim 3, wherein the second normalized value is a Key Performance Indicator (KPI) score and the summary score is an Objective.

5. The computer-implemented method of claim 4, wherein the KPI score is associated with a trend type, and wherein the trend type includes at least one of an “increase is better”, a “decrease is better”, and an “on-target is better”.

6. The computer-implemented method of claim 4, further comprising:
determining another summary score based on weighted averaging of at least two summary scores in a substantially similar way as determining the summary score, wherein the second summary score is associated with a parent node of the evaluated KPI.

7. The computer-implemented method of claim 6, further comprising:
presenting the KPI score, the Objective, and the Perspective to a user.

8. The computer-implemented method of claim 6, further comprising:
presenting a plurality of KPI scores, Objectives, and Perspectives to a user, wherein a subset of KPI scores are grouped in a Theme and another subset of KPI scores are grouped in an Initiative.

9. The computer-implemented method of claim 1, wherein each band within the first scale and each band within the second scale is assigned an indicator.

10. The computer-implemented method of claim 9, wherein the indicators include one of a set of predetermined default symbols and a color-coded scale.

11. The computer-implemented method of claim 1, wherein the number of bands within the first scale, the number of bands within the second scale, the indicators, and the boundaries of the bands are determined by one of a set of default parameters and a set of user-defined parameters.

12. The computer-implemented method of claim 1, wherein the first scale and the second scale are determined based on one of the lower bound value and the upper bound value of the measure, normalized lower bound and upper bound values of the measure, Multi-Dimensional eXpression (MDX) determined lower bound and upper bound values of the measure, and user-defined lower bound and upper bound values for the measure.

13. The computer-implemented method of claim 1, wherein the data associated with the heterogeneous measures is received from at least one of a multi-dimensional database, a regular database, and user input.

14. A computer-readable medium that includes computer-executable instructions for generating summary scores from heterogeneous measures stored in a multi-dimensional hierarchy structure, the instructions comprising:
retrieving data associated with at least one measure from a multi-dimensional database;
determining an actual scale between a lower bound value and an upper bound value for the measure that includes a predetermined number of actual bands;
assigning a value within one of the actual bands to the retrieved data based on a comparison of the data with the actual scale;
determining a band percentage value based on dividing a distance between a lower boundary of the actual band, in which the value is assigned and the value by a length of the actual band;
establishing an evenly distributed scale comprising a number of evenly distributed bands, wherein a number of the evenly distributed bands is the same as the number of actual bands, and wherein boundaries of the evenly distributed bands are equidistant;
mapping a new value on the evenly distributed scale to the value on the actual scale;
determining a total band distance by subtracting a lower boundary value of an evenly distributed band, to which the new value is assigned, from an upper boundary of the same band;
determining an in-band distance by multiplying the total band distance with the band percentage value; and
determining a KPI score based on adding the lower boundary value of the evenly distributed band to the in-band distance.

15. The computer-readable medium of claim 14, the instructions further comprising:
determining a parent node score by multiplying each of at least two KPI scores with a weighting factor that is assigned to each KPI score, wherein each KPI score is associated with a different measure, and wherein the parent node is one of an Objective and a KPI Group;
adding the at least two KPI scores multiplied with the weighting factors; and
dividing the sum of weighted KPI scores by a sum of all weighting factors.

16. The computer-readable medium of claim 15, the instructions further comprising:
determining another parent node score based on one of at least two parent node scores in a substantially similar way as determining the parent node score, wherein the other parent node is one of a Perspective and a parent KPI Group;
presenting the KPI score, the parent node score, and the other parent node score to the user.

17. The computer-readable medium of claim 16, wherein a subset of the KPI scores are grouped in a Theme and another subset of the KPI scores are grouped in an Initiative.

18. The computer-readable medium of claim 14, wherein the actual scale and the evenly distributed scale are determined based on one of actual lower bound and upper bound values of the measure, normalized lower bound and upper bound of the measure, Multi-Dimensional eXpression (MDX) determined lower bound and upper bound values of the measure, and user-defined lower bound and upper bound values for the measure.

19. A system for generating summary scores from heterogeneous measures stored in a multi-dimensional hierarchy structure, the system comprising:
a first computing device configured to store a multi-dimensional database that includes data associated with the heterogeneous measures;
a second computing device in connection with the first computing device configured to receive user input associated with processing the data associated with the heterogeneous measures;
a third computing device that is configured to execute computer-executable instructions associated with processing the heterogeneous measures, the computer-executable instructions comprising:
retrieving data associated with at least one measure from a multi-dimensional database;
determining an actual scale between a worst case value and a best case value for the measure that includes a predetermined number of actual bands;
assigning a value within one of the actual bands to the retrieved data based on a comparison of the data with the actual scale;
determining a band percentage value based on dividing a distance between a lower boundary of the actual band, in which the value is assigned and the value by a length of the actual band;
establishing an evenly distributed scale comprising a number of evenly distributed bands, wherein a number of the evenly distributed bands is the same as the number of actual bands, and wherein boundaries of the evenly distributed bands are equidistant;
mapping a new value on the evenly distributed scale to the value on the actual scale;
determining a total band distance by subtracting a lower boundary value of an evenly distributed band, to which the new value is assigned, from an upper boundary of the same band;
determining an in-band distance by multiplying the total band distance with the band percentage value; and
determining a KPI score based on adding the lower boundary value of the evenly distributed band to the in-band distance; and
a fourth computing device that is configured to present the summary scores generated by the third computing device to at least one of a user and a network.

20. The system of claim 19, wherein the first, the second, the third, and the fourth computing devices are integrated into one device.
